(19) United States
(12) Patent Application Publication
(10) Pub. No.: US 2018/0056749 A1
(43) Pub. Date: Mar. 1, 2018

(54) INCAR SENSOR MODULE FOR VEHICLE

(71) Applicant: Hyundai Motor Company, Seoul (KR)

(72) Inventors: Myung Hoe KIM, Seoul (KR); Sang Yeop LEE, Gunsan-si (KR)

(73) Assignee: Hyundai Motor Company, Seoul (KR)

(21) Appl. No.: 15/377,065

(22) Filed: Dec. 13, 2016

(30) Foreign Application Priority Data
Aug. 23, 2016 (KR) 10-2016-0106804

(51) Int. Cl. B60H 1/00

(52) U.S. Cl. CPC B60H 1/00285; B60H 1/00878

(57) ABSTRACT

An incar sensor module for a vehicle having advantages of improving a temperature detecting performance of an incar sensor detecting may include incar sensor module for the vehicle including an incar sensor mounted to a back face of a center fascia panel and an air aspirator in which an inside air inlet pipe, an air outlet pipe, and an air exhaust pipe are arranged in three directions, wherein the inside air inlet pipe of the air aspirator is connected with a connection hose extended from the incar sensor, and the air outlet pipe of the air aspirator is mounted to a connecting duct that connects a heater unit and an air blower, and the air exhaust pipe of the air aspirator is mounted to an intake of the air blower.

### CROSS-REFERENCE TO RELATED APPLICATION

The present application claims priority to Korean Patent Application No. 10-2016-0106804 filed on Aug. 23, 2016, the entire contents of which is incorporated herein for all purposes by this reference.

### BACKGROUND

### Field of the Invention

The present invention relates to an incar sensor module for a vehicle, and more particularly, to an incar sensor module for a vehicle configured to improve a temperature detecting performance of an incar sensor detecting an inside air temperature of the vehicle.

### Description of Related Art

A center fascia panel, to which panels of an audio, a navigation, and an air conditioner, and so on are mounted, is positioned at a front surface portion positioned between a driver seat and a passenger seat in an inside of the vehicle.

Referring to FIG. 1, an air inlet 12 for inhaling inside air of the vehicle is formed at the center fascia panel 10 and an incar sensor module 100 for detecting an inside air temperature is mounted to a back face portion of the air inlet 12.

Herein, mounting structure of a conventional incar sensor module will hereinafter be described.

Referring to FIG. 2, an air aspirator 120 for inhaling inside air through connection hose 112 is connected with the incar sensor 110, and the air aspirator 120 is connected with a side face portion (the position where an evaporator core included in the heater unit is provided) of a heater unit 20 of an air conditioning system which is positioned in a rear surface of the center fascia panel 10.

As shown in FIG. 3, the air aspirator 120 is manufactured by a structure that an inside air inlet pipe 121 connected with the incar sensor 110 through connection hose 112, an air outlet pipe 122 connected with the heater unit 20, and an air exhaust pipe 123 are arranged in three directions, and a first air passage 124 extended from the air outlet pipe 122 to the air exhaust pipe 123 in a curved line and a second air passage 125 extended from the inside air inlet pipe 121 to the air exhaust pipe 123 in a straight line are formed therein.

In addition, an inside end portion of the inside air inlet pipe 121 is further extended toward the air exhaust pipe 123 to be a state of being positioned in the first air passage 124.

Therefore, between an outside diameter surface of the inside air inlet pipe 121 positioned in the first air passage 124 and an inside diameter surface of the air exhaust pipe 123, a section 126 where a cross-section area of the first air passage 124 is to be decreased is formed.

Thus, when air is discharged through the air outlet pipe 122 of the air aspirator 120 from the heater unit 20 by a blowing operation of an air conditioning system, the discharged air is exhausted to outside through the air exhaust pipe 123 after flowing along the first air passage 124.

At this time, when the air discharged from the heater unit 20 passes between an outside diameter surface of the inside air inlet pipe 121 and the inside diameter surface of the air exhaust pipe 123 (through the section 126 where a cross-section area of the first air passage 124 is to be decreased), a pressure of a rear end portion of the air exhaust pipe 123 is temporarily to be lower than that of the inside air inlet pipe 121.

Simultaneously, as a pressure of the rear end portion of the air exhaust pipe 123 is temporarily to be low, vehicle inside air is inhaled through the inside air inlet pipe 121 and then is exhausted through the air exhaust pipe 123 together with the air discharged from the heater unit 20.

More particularly, according to a principle of generating pressure difference that a pressure of the rear end portion of the air exhaust pipe 123 is temporarily to be lower than that of the inside air inlet pipe 121, vehicle inside air flows into the inside air inlet pipe 121 of the air aspirator 120 through the connection hose 112 connected with the incar sensor 110 after being inhaled into the incar sensor 110 through the air inlet 12 of the center fascia panel 10 and then is exhausted through the air exhaust pipe 123.

At this time, when inside air of the vehicle is inhaled into the incar sensor 110, the incar sensor 110 detects a temperature of the inside air.

But, the following problems occur in the above-mentioned conventional incar sensor module.

Firstly, as cold air discharged from a heater unit of an air conditioning system is discharged through an air exhaust pipe of an air aspirator and then is flowed into the inside (a lower side of a driver seat), there is a problem that a driver feels the cold from the driver's lower body.

Concretely, the air discharged from the heater unit of the air conditioning system is discharged from a rear end of an evaporator core in the heater unit and thus it is always discharged in a cold state, and in addition, as an outlet of the air exhaust pipe of the air aspirator is positioned to be in communication with an air duct (an air duct which discharges air to the lower side of the driver seat during the driving mode of an air conditioner) of the lower side of the driver seat, the cold air discharged from the heater unit flows into the inside through the air duct of the lower side of the driver seat after being discharged through the air exhaust pipe via an air outlet pipe of the air aspirator such that a sense of difference (i.e. feeling cold) from the driver's lower body occurs while heating in the winter.

Secondly, as there are many resistant elements while outside air inhaled from an air blower of the air conditioning system reaches the heater unit, it is difficult to secure an air volume being discharged from the heater unit toward the air outlet pipe of the air aspirator when the blower is operated with lower stages, thus suction force of vehicle inside air is reduced according to the principle of inhaling inside air by the air aspirator, as a result, there is a problem that inside air passing through an incar sensor is reduced such that the incar sensor cannot correctly sense an inside temperature.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an incar sensor module for a vehicle having advantages of securing an air volume being discharged to the air aspirator even while an air blower is operated with lower stages and preventing that cold air flows into an inside in the winter as air aspirator is mounted at a connecting duct between a heater unit and the air blower such that inside air passing through an incar sensor and air passing through the connecting duct are discharged to an intake side of the air blower and then are re-circulated toward the connecting duct.

Various aspects of the present invention are directed to providing an incar sensor module for a vehicle, including: an incar sensor mounted to a back face of a center fascia panel and an air aspirator in which an inside air inlet pipe, an air outlet pipe, and an air exhaust pipe are arranged in three directions, wherein the inside air inlet pipe of the air aspirator is connected to a connection hose extended from the incar sensor; the air outlet pipe of the air aspirator is connected to a connecting duct that connects a heater unit and an air blower; and the air exhaust pipe of the air aspirator is mounted to an intake of the air blower.

Particularly, an air inhaling passage extended from the inside air inlet pipe to the air exhaust pipe in a straight line shape may be formed in the air aspirator, and the air outlet pipe may be extended toward the air exhaust pipe in a curved line shape and may be positioned in the air inhaling passage.

In addition, a section where a cross-section area of the air inhaling passage is to be decreased may be formed between an inside diameter surface of the inside air inlet pipe and an outside diameter surface of the air outlet pipe positioned in the air inhaling passage.

Desirably, air discharged from the connecting duct to the air outlet pipe may be discharged to the intake of the air blower through the air exhaust pipe, and simultaneously, inside air inhaled through the inside air inlet pipe after passing through the incar sensor may be also discharged to the intake of the air blower through the air exhaust pipe.

According to the above mentioned problem solving means, hereinafter mentioned effects are provided in an exemplary embodiment of the present invention.

Firstly, as the air outlet pipe of the air aspirator is mounted to the connecting duct connecting the heater unit and the air blower, and simultaneously, the air exhaust pipe of the air aspirator is mounted to the intake of the air blower such that inside air passing through the incar sensor and air flowing from the connecting duct are discharged toward the intake of the air blower and then are re-circulated toward the connecting duct, it may be blocked that cold air discharged from the air aspirator flows into the inside and thus the problem in the related art (cold inside air flowing into a lower side of a driver seat) can be prevented.

Secondly, the air volume being discharged through the air outlet pipe of the air aspirator can be easily secured even while an air blower is operated with lower stages as the air outlet pipe of the air aspirator is mounted to the connecting duct positioned between the heater unit positioned near the air blower and the air blower and thus detecting performance of the incar sensor to sense an inside temperature can be improved as it is easily performed to inhale inside air passing through the incar sensor.

Other aspects and exemplary embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram showing that an air inlet for inhaling inside air into a center fascia panel of a vehicle is formed;

FIG. 2 is a perspective view showing a state of mounting a conventional incar sensor module;

FIG. 3 is a cross-sectional view by B-B of FIG. 2 showing an air aspirator of a conventional incar sensor module;

FIG. 4 is a perspective view showing a state of mounting an incar sensor module according to an exemplary embodiment of the present invention; and

FIG. 5 is a cross-sectional view by A-A of FIG. 4 showing an air aspirator of an incar sensor module according to an exemplary embodiment of the present invention.

It should be understood that the appended drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

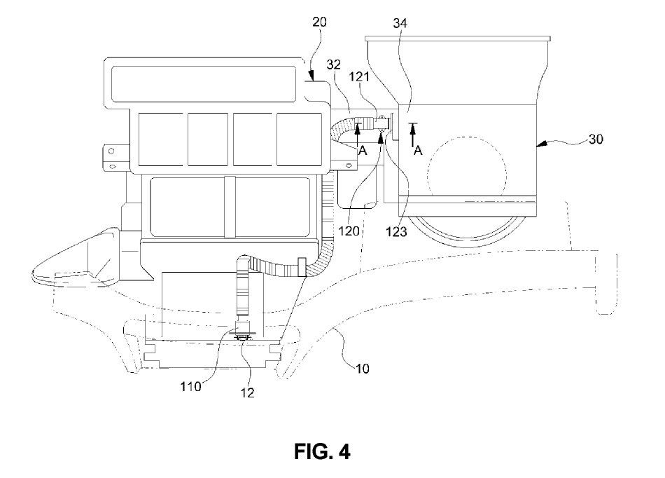

FIG. 4 illustrates a perspective view showing a state of mounting an incar sensor module according to an exemplary embodiment of the present invention.

Referring to FIG. 4, the incar sensor module is configured to include an incar sensor 110 which is mounted to a back face of a center fascia panel and an air aspirator 120 in which an inside air inlet pipe, an air outlet pipe, and an air exhaust pipe are arranged in three directions.

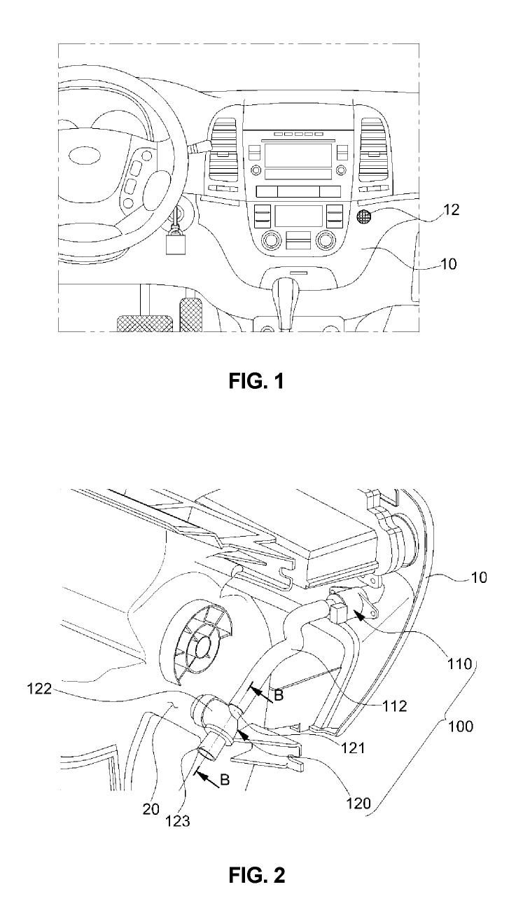

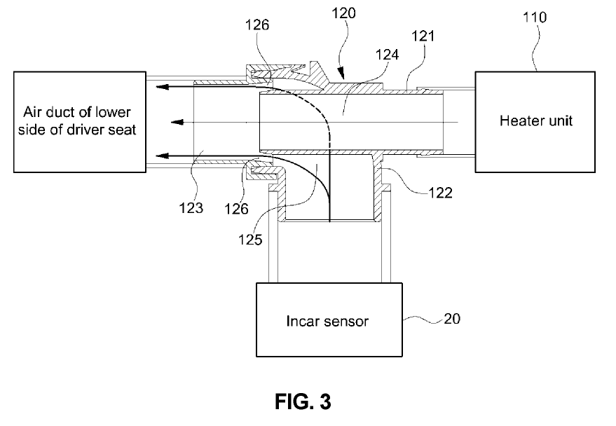

The incar sensor 110 is mounted to a back face of an air inlet 12 (referring to FIG. 1) of the center fascia panel 10 to be applied as a temperature sensor detecting an inside air temperature, and also applied as a humidity sensor detecting an inside air humidity.

The air aspirator 120 may be applied as a kind of a jet pump inhaling fluid by using pressure difference, and inhales inside air of a vehicle toward the incar sensor 110 such that the incar sensor 110 easily detects inside air temperature.

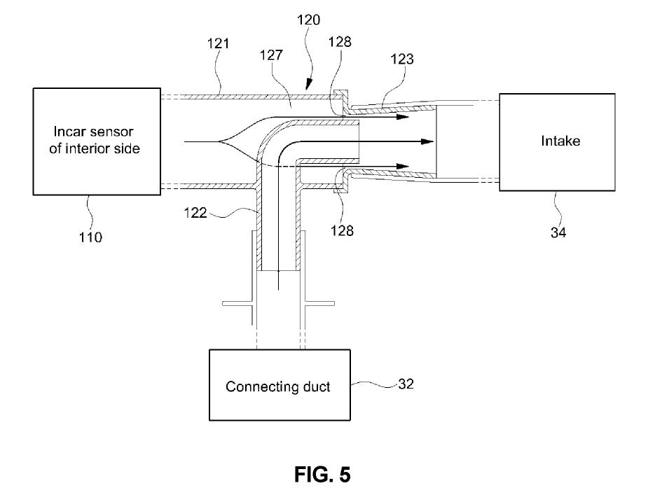

To this end, the air aspirator 120 is manufactured by a structure that an inside air inlet pipe 121, an air outlet pipe 122, and an air exhaust pipe 123 are arranged in three directions as shown in FIG. 5.

In addition, an air inhaling passage 127 extended from the inside air inlet pipe 121 to the air exhaust pipe 123 in a straight line shape are formed in the air aspirator 120.

Further, an air outlet pipe 122, which is extended in a curved line shape toward the air exhaust pipe 123, is positioned at the air inhaling passage 127 formed in the air aspirator 120.

Therefore, a section 128 where a cross-section area of the air inhaling passage 127 is to be decreased is formed between an inside diameter surface of the inside air inlet pipe 121 and an outside diameter surface of the air outlet pipe 122 positioned in the air inhaling passage 127.

Herein, the inside air inlet pipe 121 of the air aspirator 120 positioned as mentioned above is connected with a connection hose 112 extended from the incar sensor 110, and the air outlet pipe 122 is mounted to a connecting duct 32 connecting a heater unit 20 and an air blower 30, and the air exhaust pipe 123 is mounted to an intake 34 of the air blower 30.

At this time, the intake 34 means a manifold route into which outside air is initially inhaled when the air blower 30 is operated, and the connecting duct 32 means an air passage through which outside air is transferred to the heater unit 20 after being inhaled into the intake 34 when the air blower 30 is operated.

Therefore, when outside air being inhaled into the intake 34 by operating the air blower 30 passes through the connecting duct 32, outside air is discharged through the air outlet pipe 122 of the air aspirator 120 from the connecting duct 32 and the discharged air is discharged to the intake 34 of the air blower 30 through the air exhaust pipe 123.

In addition, inside air inhaled into the inside air inlet pipe 121 of the air aspirator 120 after passing through the incar sensor 110 is also discharged to the intake 34 of the air blower 30 through the air exhaust pipe 123.

Herein, an operational flow of the incar sensor module according to an exemplary embodiment of the present invention having the above mentioned configuration will hereinafter be described.

Firstly, when outside air being inhaled into the intake 34 passes through the connecting duct 32 by the operation of the air blower 30, outside air is discharged from the connecting duct 32 to the air outlet pipe 122 of the air aspirator 120 and then the discharged air is discharged to the intake 34 of the air blower 30 through the air exhaust pipe 123.

Thus, when outside air flowing from the connecting duct 32 is discharged to the air outlet pipe 122 having a curved line shape positioned at the air inhaling passage 127 in the air aspirator 120, a pressure of the section 128 where a cross-section of the air inhaling passage 127 is to be decreased is for a predetermined time to be lower than that of inside air inlet pipe 121 by a velocity of flow of air being discharged.

Therefore, when a pressure of the section 128 where a cross-section area of the air inhaling passage 127 is to be decreased is for a predetermined time to be lower than that of inside air inlet pipe 121, suction force acts to inside air of the vehicle flowing into the inside air inlet pipe 121 so that inside air of the vehicle flows into the inside air inlet pipe 121 through the connection hose 112 connected with the incar sensor 110 after being inhaled into the incar sensor 110 through the air inlet 12 of the center fascia panel 10 by this suction force and then is discharged to the intake 34 of the air blower 30 through the air exhaust pipe 123.

Meanwhile, outside air flowed from the connecting duct 32 and inside air inhaled through the inside air inlet pipe 121 are re-circulated to the connecting duct 32 after being discharged together to the intake 34 of the air blower 30.

Thus, as inside air passing through the incar sensor 110 and air flowing from the connecting duct 32 are discharged toward the intake 34 of the air blower 30 and then are re-circulated toward the connecting duct 32, it may be blocked that cold air discharged from the air exhaust pipe 123 of the air aspirator 120 flows into the inside, and thus the conventional problem that cold inside air flows into a lower side of a driver seat can be prevented.

In addition, the air volume being discharged to the air outlet pipe 122 of the air aspirator 120 can be easily secured even while the air blower 30 is operated with lower stages by mounting the air outlet pipe 122 of the air aspirator 120 to the connecting duct 32 positioned between the heater unit 20 positioned near the air blower 30 and the air blower 30.

Further, as the air volume being discharged to the air outlet pipe 122 of the air aspirator 120 is easily secured, inside air of a vehicle can be easily inhaled into the inside air inlet pipe 121 through the incar sensor 110.

Furthermore, the air volume of inside air passing through the incar sensor 110 is to be an air volume for certainly detecting an inside temperature in the incar sensor 110, and as a result, detecting performance of incar sensor 110 to sense inside temperature may be improved.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “interior”, “exterior”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An incar sensor module for a vehicle comprising:
an incar sensor mounted to a back face of a center fascia panel; and
an air aspirator in which an inside air inlet pipe, an air outlet pipe, and an air exhaust pipe are arranged in three directions,
wherein the inside air inlet pipe of the air aspirator is connected with a connection hose extended from the incar sensor, and the air outlet pipe of the air aspirator is mounted to a connecting duct that connects a heater unit and an air blower, and the air exhaust pipe of the air aspirator is mounted to an intake of the air blower.

2. The incar sensor module for the vehicle of claim 1, wherein an air inhaling passage extended from the inside air inlet pipe to the air exhaust pipe in a straight line shape is formed in the air aspirator, and the air outlet pipe is extended toward the air exhaust pipe in a curved line shape and is positioned in the air inhaling passage.

3. The incar sensor module for the vehicle of claim 1, wherein a section where a cross-section area of an air inhaling passage is to be decreased is formed between an inside diameter surface of the inside air inlet pipe and an outside diameter surface of the air outlet pipe positioned in the air inhaling passage.

4. The incar sensor module for the vehicle of claim 1, wherein air discharged from the connecting duct to the air outlet pipe is discharged to the intake of the air blower through the air exhaust pipe, and inside air inhaled into the inside air inlet pipe after passing through the incar sensor is also discharged to the intake of the air blower through the air exhaust pipe.
